(19) United States
(12) Patent Application Publication
(10) Pub. No.: US 2002/0179397 A1
(43) Pub. Date: Dec. 5, 2002

(54) Thrust plate assembly

(75) Inventors: Hartmut Bach, Schweinfurt (DE); Cora Carlson, Dittelbrunn (DE); Matthias Dorfler, Schweinfurt (DE); Gunther Esly, Wasserlosen (DE); Reinhard Feldhaus, Niederwerrn (DE); Ingrid Hoffelner, Knetzgau (DE); Christoph Kleuker, Springe (DE); Paul Kraus, Niederwerrn (DE); Andreas Orlamunder, Schweinfurt (DE); Bernd Peinemann, Niederwerrn (DE); Michael Peterseim, Oberdorla (DE); Gerhard Roll, Eisenheim (DE); Ralf Till, Euerbach (DE); Sebastian Vogt, Bad Neustadt (DE); Andreas Dau, Wurzburg (DE)

Correspondence Address: Thomas C. Pontani, Esq., Cohen, Pontani, Lieberman & Pavane, Suite 1210, 551 Fifth Avenue, New York, NY, 10176, US

(73) Assignee: ZF Sachs AG

(21) Appl. No.: 10/160,668

(22) Filed: May 30, 2002

(30) Foreign Application Priority Data
Jun. 1, 2001 (DE) 101 26 780.0
Oct. 11, 2001 (DE) 101 50 235.4

(51) Int. Cl. F16D 13/71

(52) U.S. Cl. 192/70.18; 192/109 R

(57) ABSTRACT

A thrust plate assembly comprises a housing arrangement and a pressure plate arrangement which is coupled by at least one coupling arrangement to the housing arrangement so as to be movable in direction of an axis of rotation (A). It further comprises an axial path limiting arrangement for limiting the axial movement of the pressure plate arrangement with respect to the housing arrangement in an axial movement direction, this axial path limiting arrangement having, at the housing arrangement, at least one stop area which is contacted by a counter-stop area of the pressure plate arrangement associated with this stop area when the pressure plate arrangement assumes a predetermined relative position with respect to the housing arrangement.

### BACKGROUND OF THE INVENTION

1. Field of the Invention

The present invention is directed to a thrust plate assembly for a friction clutch in a motor vehicle. This thrust plate assembly has a housing arrangement and a pressure plate arrangement which is coupled by at least one coupling arrangement to the housing arrangement so as to be movable in direction of an axis of rotation.

2. Description of the Related Art

In thrust plate assemblies of the type mentioned above, diaphragm springs are generally used as energy accumulators which pretension the pressure plate arrangement with respect to the housing arrangement. These diaphragm springs are constructed so as to apply the required pressing force for the pressure plate arrangement for producing the engaged state. In the engaged state, i.e., in the state in which the pressure plate arrangement presses against the friction linings of a clutch disk, the pressing force generated by the diaphragm spring is absorbed by a reaction force which is provided via the housing arrangement and flywheel. However, in a state in which the thrust plate assembly is not yet assembled with a flywheel, it is not yet possible to generate such a reaction force.

In conventional thrust plate assemblies, the pressure plate arrangement is connected in such a way with the housing arrangement by a plurality of tangential leaf springs extending essentially in a straight line and tangentially that the pressure plate arrangement can move axially with respect to the housing arrangement to a determined extent in order to carry out engaging and releasing processes. In configurations in which the flywheel is not yet mounted, these tangential leaf springs absorb the axial force generated by the energy accumulator in that they are correspondingly deflected and stretched in axial direction. Since the tangential leaf springs of a clutch of this kind are constructed so as to extend essentially in a straight line, as was already mentioned, this loading in axial direction can not result in damage to the tangential leaf springs.

Arrangements of leaf springs which are relatively sharply curved in axial direction are known in clutches having a self-reinforcing pressing force effect. That is, the two areas by which the leaf springs are connected to the housing arrangement on one hand and to the pressure plate arrangement on the other hand are clearly offset relative to one another in axial direction in order to generate an additional pressing force component through the inclined position of the tangential leaf springs when torque is introduced. When spring elements of this kind are acted upon by very high forces in axial direction, damage, for example, excessive deformation that is no longer elastic, may result in the spring elements.

### SUMMARY OF THE INVENTION

It is the object of the present invention to further develop a thrust plate assembly in such a way that the axial path of the pressure plate arrangement is limited in a state in which this thrust plate assembly is not yet joined with a flywheel without the risk of damaging any components of the thrust plate assembly.

According to a first aspect of the present invention, this object is met by a thrust plate assembly comprising a housing arrangement and a pressure plate arrangement which is coupled by at least one coupling arrangement to the housing arrangement so as to be movable in direction of an axis of rotation, and further comprising an axial path limiting arrangement for limiting the axial movement of the pressure plate arrangement with respect to the housing arrangement in an axial movement direction, this axial path limiting arrangement having, at the housing arrangement, at least one stop area which is contacted by a counter-stop area of the pressure plate arrangement associated with this stop area when the pressure plate arrangement assumes a predetermined relative position with respect to the housing arrangement.

By providing the axial path limiting arrangements with the at least one stop area and the counter-stop area associated with the latter, it is ensured that when a determined relative position of the pressure plate arrangement with respect to the housing arrangement is reached, continued movement is no longer possible, irrespective of the deformation state that may possibly have been produced in the leaf springs being used, for example, as coupling arrangements.

In a particularly preferred embodiment form which, beyond this, can provide a very stable and dependable axial path limiting function, it is preferably provided that the at least one stop area and the counter-stop area associated with it overlap one another considered in axial direction and that the counter-stop area contacts the stop area during axial movement of the pressure plate arrangement with respect to the housing arrangement in one axial movement direction.

In another particularly preferred embodiment form, the axial movement of the pressure plate arrangement with respect to the housing arrangement requires a rotating movement of the pressure plate arrangement relative to the housing arrangement and the at least one stop area forms a rotational movement stop for the counter-stop area.

For this purpose, a rotating movement of the pressure plate arrangement relative to the housing arrangement can be generated by the at least one coupling arrangement during axial movement of the pressure plate arrangement with respect to the housing arrangement, and the at least one stop area overlaps the counter-stop area axially at least when the predetermined relative position is reached.

In an embodiment form which is especially simple to manufacture but which operates reliably, the at least one stop area is provided at a radial outer rim-like area of the housing arrangement. Further, it is possible that the counter-stop area associated with the at least one stop area is provided at a projection area of the pressure plate arrangement engaging in a housing cutout. This projection area can simultaneously form a coupling portion at which a coupling arrangement can be secured to the pressure plate arrangement.

To provide the counter-stop area, it can be provided in another embodiment form, which is preferred with respect to the low number of parts, that the coupling arrangement comprises at least one coupling element, preferably a leaf spring element, which is connected near a first end area of the same with the coupling portion of the pressure plate arrangement and near a second end area of the same with a coupling portion of the housing arrangement, preferably a radial outer rim-like area of the housing arrangement, and that the counter-stop area is provided at a portion of the at least one coupling element extending beyond the area of the connection with the coupling portion of the pressure plate arrangement.

According to another aspect of the present invention, the above-stated object is met by a thrust plate assembly comprising a housing arrangement, a pressure plate arrangement which is coupled by at least one coupling arrangement to the housing arrangement so as to be movable in direction of an axis of rotation, and an energy accumulator which is supported with respect to the housing arrangement on one side and with respect to the pressure plate arrangement on the other side, and the pressure plate arrangement is pretensioned for moving with respect to the housing arrangement in an axial movement direction, further comprising an axial path limiting arrangement for limiting the axial movement of the pressure plate arrangement with respect to the housing arrangement in one axial movement direction, wherein the axial path limiting arrangement comprises a movement stop for the energy accumulator.

In this embodiment variant, the movement stop is provided in the area of its member which ultimately generates the force moving the pressure plate arrangement out of the housing arrangement. Accordingly, no special construction steps are required at the pressure plate arrangement itself to provide the axial path limiting.

It can be provided, for example, that the movement stop is provided at the housing arrangement. A particularly preferred embodiment form of a thrust plate assembly of this kind which operates according to the principle of a push-type clutch can be constructed in such a way that the energy accumulator, in its radial outer area, acts on the pressure plate arrangement and is supported in both axial directions in its radial middle area with respect to the housing arrangement and can be acted upon by a release arrangement in its radial inner area, and that when the pressure plate arrangement has a predetermined relative position with respect to the housing arrangement the energy accumulator comes into contact with the movement stop with a portion located between the radial middle area and the radial inner area.

The invention is further directed to a friction clutch comprising a thrust plate assembly according to the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal section through a friction clutch;

FIG. 2 is a schematic axial view of the pressure plate of the friction clutch shown in FIG. 1, which pressure plate is coupled with a housing arrangement;

FIG. 3 shows the principle of operation of a clutch with self-reinforcing action;

FIG. 4 shows a partial sectional view of a thrust plate assembly according to the invention from the radial outside;

FIG. 5 is a view corresponding to FIG. 4 showing an alternative embodiment form;

FIG. 6 is a view corresponding to FIG. 4 showing an alternative embodiment form;

FIG. 7 is a view corresponding to FIG. 4 showing an alternative embodiment form;

FIG. 8 is a view corresponding to FIG. 4 showing an alternative embodiment form; and

FIG. 9 shows a schematic longitudinal section through a thrust plate assembly according to the invention in another alternative construction.

### DETAILED DESCRIPTION OF THE PRESENTLY PREFERRED EMBODIMENTS

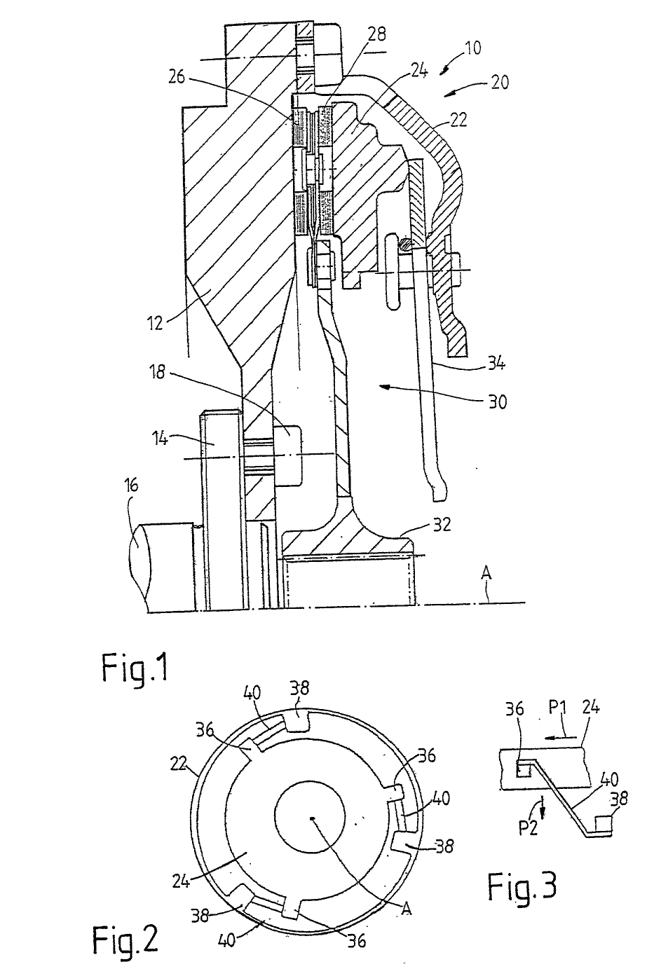

The basic construction of a friction clutch 10 in which the inventive principles are or can be realized is shown in FIGS. 1 and 2. The friction clutch 10 comprises a flywheel 12 which can be constructed, for example, as a dual-mass flywheel which is secured in the radial inner area to a crankshaft flange 14 of a crankshaft 16 or some other drive shaft by a plurality of screw bolts 18. In its radial outer area, the flywheel 12 is fixedly connected with a thrust plate assembly 20. The thrust plate assembly 20 comprises a housing 22 and a pressure plate 24 which is axially displaceable in the housing 22 but is held so as to be substantially fixed with respect to rotation relative to the housing 22. The friction facings 26, 28 of a clutch disk 30 are located between the pressure plate 24 and the flywheel 12. This clutch disk 30 can be coupled in its radial inner hub area 32 with a driven shaft, for example, a transmission input shaft, so as to be fixed with respect to rotation relative to it. The pressure plate 24 is pretensioned basically in the direction of the flywheel 12 by an energy accumulator 34, for example, a diaphragm spring. In the present example, the clutch 10 is a push-type clutch.

As is shown in FIG. 2, coupling portions 36 and 38, respectively, as provided at the pressure plate 24 and at the housing arrangement 22 or, as the case may be, also at the flywheel 12. One of the coupling portions 36 and one of the coupling portions 38 are connected with one another by a coupling arrangement 40 extending approximately in circumferential direction. These coupling arrangements 40 are formed of flexible elements so that, in principle, an axial movement of the pressure plate 24 is possible for carrying out engagement and release processes. When the coupling portions 36, 38 are offset relative to one another in direction of the axis of rotation as is illustrated in FIG. 3 and the coupling arrangements 40 extend in the manner shown in FIG. 3, an application of force of the pressure plate 24 in circumferential direction with respect to the housing arrangement 22 in the direction indicated by the arrow P₁, which occurs, for example, in pull operation, results in a deflection of force due to lever ratios and leads to a reinforcement of the pressing force exerted on the friction facings 28, 26 by the pressing force 24, which reinforcement is directed as indicated by arrow P₂. In this type of clutch 10 with a self-reinforcing effect, it is possible to achieve pressing forces which are fundamentally higher than those that can be attained by conventional diaphragm springs while still allowing actuation. If an extremely high pressing force is not required, it is possible to provide the diaphragm spring and the energy accumulator 34 with lower pressing force capacity so that smaller release forces are also required.

It should be noted that only the basic construction of a friction clutch with self-reinforcing effect has been described thus far. Of course, a wide range of changes can be implemented in a clutch of this kind whether or not the principles of the present invention are applied, e.g., providing a wear compensating arrangement, a multi-mass flywheel as was already mentioned, a torsional vibration damper in the area of the clutch disk, and so on.

FIG. 4 shows a thrust plate assembly 20, according to the invention, in which an axial path limiting arrangement 44 is provided for the pressure plate 24. However, it should first be pointed out that the coupling arrangements 40 in this embodiment form comprise leaf spring elements, namely, two leaf spring elements 42, 42′. As was already shown in FIG. 2, these leaf spring elements 42, 42′ are secured in a first end area 46 to a coupling portion 36 of the pressure plate by a rivet stud 48 and are secured in a second end area 50 to the coupling portion 38 of the housing 22 by means of a rivet stud 52. The two leaf spring elements are held at an axial distance from one another by inserting two spacers, for example. Further, it will be seen that the two end areas 46, 50 are offset with respect to one another in axial direction to provide the above-mentioned self-reinforcement effect, so that the leaf springs 42, 42′ extend in a curved manner. The coupling portion 38 can be formed, for example, at a rim-like or flange-like area 54 which projects radially outward from the housing 22 and is formed by bending.

When the flywheel is not connected with this thrust plate assembly, it must be ensured that the pressure plate 24 can not move so far out of the housing under the influence of the energy accumulator that the coupling arrangements or leaf spring elements 42, 42′ of the same are excessively loaded or deformed. In order to ensure this, the axial path limiting arrangement 44 comprises tab-shaped rim portions 58 of the rim-like area 54 of the housing 22 in the area of the arm-like coupling portions 36 projecting radially outward from the pressure plate 24 and engaging in respective recesses 56 in the radial outer area of the housing 22, which tab-shaped rim portion 58 likewise extend in the area of these cutouts 56. A stop area 60 is formed at a rim portion 58 of the housing 22 associated with a respective coupling portion 36, a corresponding counter-stop area 62 at the pressure plate, namely, at the respective coupling portion 36 of the same, overlaps this stop area 60 considered in axial direction. When considered from the radial outside, this appears as the circumferential overlap shown in FIG. 4.

When the pressure plate 24 moves in axial direction accompanied by pretensioning of the energy accumulator 34, specifically, in the direction out of the housing 22 in which the assembly formed of the clutch disk 30 and flywheel 12 would otherwise provide a reaction force, the counter-stop area 62 approaches the stop area 60 of the housing 22 and finally contacts it. Since an at least slight rotational movement in circumferential direction is caused at the same time as this axial movement due to the curved coupling arrangements 40, the existing overlapping of the two areas 60, 62 is further increased during the axial movement, so that the axial path limiting function is reliably ensured.

When a thrust plate assembly 20 of this type is assembled, it must be ensured that the pressure plate 24 is inserted into the housing 22 with a slight rotating movement, so that the tab-like rim areas 58 ultimately move into the position in which the coupling portions 36 are embraced in circumferential direction and accordingly also overlapped considered in axial direction.

In this embodiment form, it is significant that, ultimately, no additional components are provided or need to be secured to the thrust plate assembly 22 in order to obtain the axial path limiting function. Rather, the tab-like area 58 can be formed integral in the area of every cutout 56 during the shaping or punching process by which the housing arrangement 22 is produced. However, it is also possible to arrange a separate stop element at the housing arrangement 22.

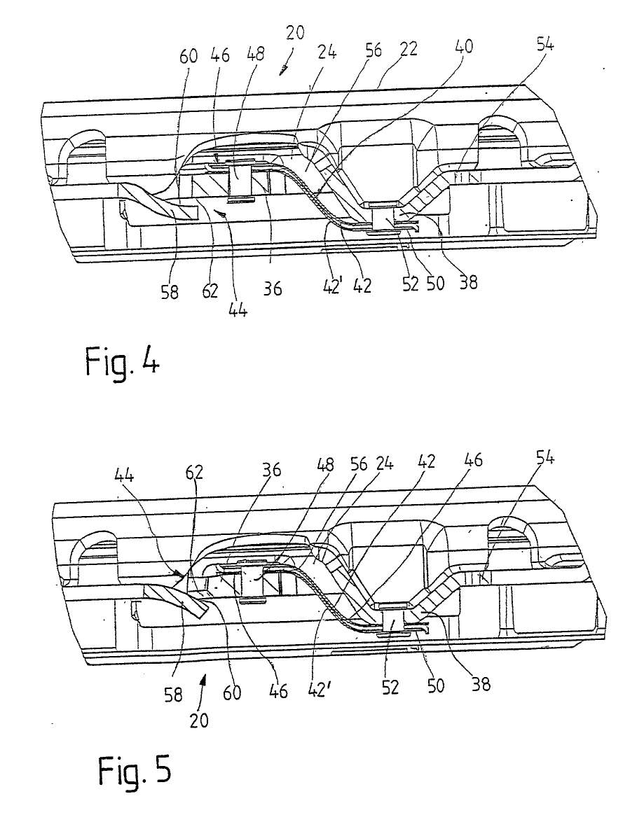

In the embodiment form shown in FIG. 5, the tab-like rim portion 58 producing the stop area 60 curves away slightly from the associated coupling portion 36. In order to achieve area contact in this arrangement, the coupling portion 36 is slightly sloped or beveled in its counter-stop area 62, which can be carried out in one work step, for example, in the process of producing the pressure plate 24. During the combined axial and rotational movement mentioned above, the pressure plate 24 moves with its counter-stop area 62 toward the stop area 60 and comes into area contact with it. Accordingly, not only is an axial force transmitted between these two areas, but a circumferential force component is also transmitted. Finally, a limiting of the rotational path is achieved in this way for the pressure plate 24.

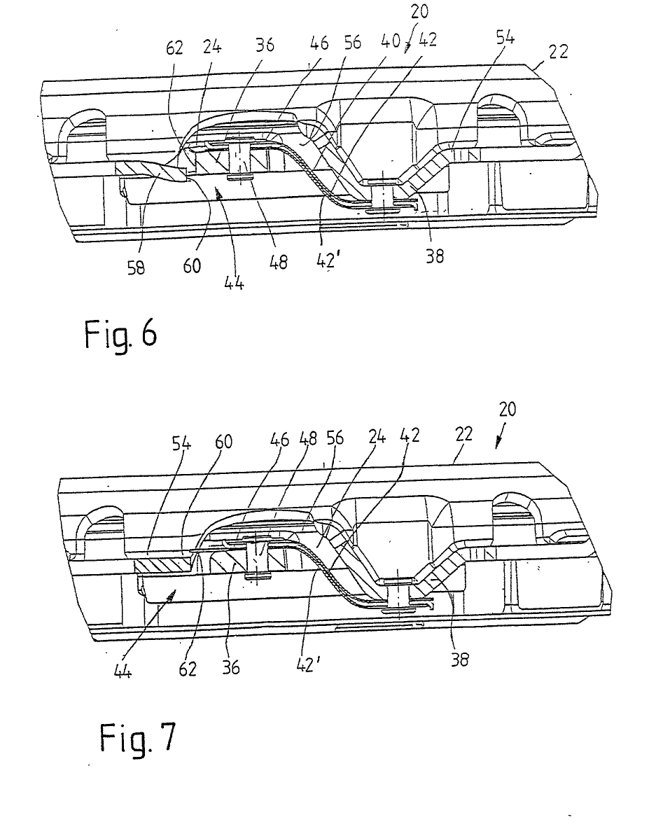

In the variant shown in FIG. 6, the tab-like rim portion 58 which projects at least slightly into the cutout 56 forms the stop area 60 by its end face directed in circumferential direction. A front face or side face situated in the opposite circumferential direction forms the counter-stop area 62 of the pressure plate 24 or coupling portion 36 in a corresponding manner. As was already mentioned above, during the axial movement of the pressure plate 24 compelled by the energy accumulator 34, a movement component is caused in the rotating direction, specifically, by means of the coupling arrangements 40 which ultimately impede a purely axial displacement due to their angled installation position. This means that an axial movement is not possible without a rotating movement also occurring or being permitted at the same time. The embodiment form according to FIG. 6 makes use of this in that it forms a rotational movement stop with the two areas 60, 62 which can be brought into contact one another. After a determined position is reached during the combined axial and rotational movement of the pressure plate 24, this rotational movement stop does not permit further rotation or further axial movement. For this purpose, an axial overlap is required at least in the state in which the two areas 60, 62 come into contact with one another, as can also be seen in FIG. 6.

A substantial advantage of this constructional variant is that no rotating movements are required for joining the housing 22 with the pressure plate 24, since the pressure plate 24 can be inserted into the cutouts 56 of the housing 22 in axial direction by their coupling portions 36 which project radially outward.

In the construction variant shown in FIG. 7, the stop area 60 is again provided at the rim area 54 of the housing 22, but not at a portion projecting in circumferential direction in the area of the cutout 56. Rather, in this variant, in order to provide the counter-stop area 62 of one of the leaf spring elements 42, 42′, the leaf spring element 42′ in this example is lengthened beyond its area provided for fixedly connecting to the coupling portion 36 and accordingly protrudes over the coupling portion 36 in circumferential direction. It must extend at least far enough that the counter-stop area 62 provided at the leaf spring element 42′ overlaps the stop area 60 at the housing 22 and comes into contact at the latter when a determined axial position of the pressure plate is reached and after the rotational movement of the same which was also necessary for this purpose. In this case also, a substantial advantage consists in that a very simple assembly process can be achieved and that, further, no special structural measures need to be carried out at the housing 22 to achieve the axial path limiting function. Further, a movement damping is achieved when contact is made because of the elasticity of the leaf spring element 42.

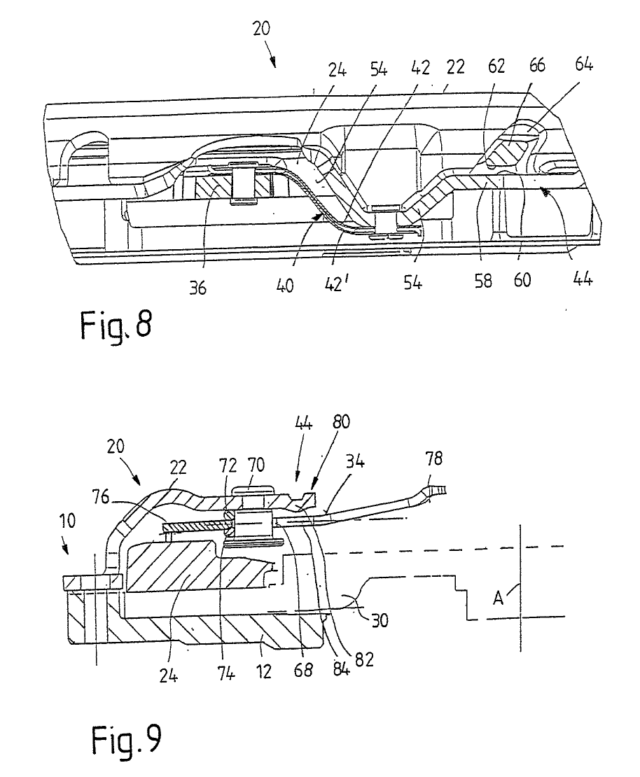

In the embodiment form shown in FIG. 8, stop projections 66 are provided at the pressure plate 24. These stop projections 66 are formed separately by the coupling portions 36 projecting radially outward and engage radially outward in associated cutouts 64 of the housing 22. Tab-like portions 58 of the rim area 54 which again extend in circumferential direction in the area of the cutouts 64 are associated with the stop projections 66. During the axial movement of the pressure plate 24 with respect to the housing 22, the stop projections 64 approach the respective stop areas 60 formed at the tab-like areas 58 with the counter-stop areas 62 that are now provided at the stop projections 64 and come into contact with the stop areas 60. The stop projections 66 not only function as axial movement stops, but simultaneously also form a rotational movement stop for the pressure plate 24. This function is particularly advantageous in overrun or push operation in order to prevent excessive compression loading of the coupling arrangements 40 and leaf spring elements 42, 42′. In order to provide this rotational movement limiting, the stop projections 66, with surface regions located on the sides or in circumferential direction, come into contact with the wall of the housing 22 defining the cutout 64.

FIG. 9 shows another embodiment form of an axial path limiting arrangement 44 in a thrust plate assembly 20 and friction clutch 10. It will be seen again that the friction clutch 10 has the energy accumulator 34 which is supported in both axial directions in its radial middle area 68 with respect to the housing 22 by a plurality of spacer pins 70 and, for example, two wire rings 72, 74. In the radial outer area 76, the energy accumulator 34 acts upon the pressure plate 24, possibly via a wear adjustment device, and the energy accumulator 34 can be acted upon in its radial inner area 78 by a release mechanism. A movement stop 82 which is formed, for example, by shaping and is preferably continuous in circumferential direction is provided for a portion 84 of the energy accumulator 34 situated between the radial inner area 78 and the radial middle area 68 at a radial inner area 80 of the housing 22 which is generally ring-shaped.

When the pressure plate 24 moves axially out of the housing 22 under the effect of the energy accumulator 34, that is, downward with respect to FIG. 9, due to deficient opposing force, the energy accumulator 34 tilts in a corresponding manner and approaches the movement stop 82 with its portion 84. When a given relative axial position is reached, these two areas contact one another. A further swiveling of the energy accumulator 34 is then impossible. Since the pressure plate 24 is acted upon in a direction opposite to the effective direction of the energy accumulator 34, for example, by means of the coupling arrangements 40 shown in the preceding Figures or other lifting force generating arrangements, a defined contact is nevertheless maintained between the pressure plate 24 and the energy accumulator 34 in its radial outer area 76.

The present invention proposes various steps which contribute to the prevention of excessive axial displacement of the pressure plate when the thrust plate assembly is not yet joined with the flywheel, which axial displacement involves the risk of damage to coupling members, e.g., curved leaf spring elements. All steps can be provided in an extremely simple manner with respect to construction because they ultimately do not require any additional elements and because they can be realized by simple forming or shaping steps.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A thrust plate assembly comprising
a housing,
a pressure plate,
a coupling arrangement coupling said pressure plate to said housing so that said pressure plate is movable relative to said housing in the direction of an axis of rotation, and
an axial path limiting arrangement comprising at least one stop area at the housing and at least one counter-stop area at the pressure plate, each said counter-stop area contacting a corresponding said stop area when the pressure plate assumes a predetermined position relative to the housing, thereby limiting axial movement of the pressure plate with respect to the housing.

2. A thrust plate assembly as in claim 1 wherein each said stop area overlaps a corresponding said counter-stop area in the axial direction, said counter-stop area contacting said stop area during axial movement of the pressure plate relative to the housing.

3. A thrust plate assembly as in claim 1 wherein the axial movement of the pressure plate relative to the housing requires a rotating movement of the pressure plate relative to the housing, said at least one stop area forming a rotational stop for the counter-stop area.

4. A thrust plate assembly as in claim 3 wherein said rotating movement is generated by the coupling arrangement during said axial movement, each said stop area overlapping a corresponding said counter-stop area when the predetermined position has been reached.

5. A thrust plate assembly as in claim 1 wherein said housing comprises a radially outer rim-like area which forms said at least one stop area.

6. A thrust plate assembly as in claim 1 wherein said pressure plate comprises a projection area which forms said at least one counter stop area, said housing having a cutout in which said projection area engages.

7. A thrust plate assembly as in claim 6 wherein said projection area forms a coupling portion, said coupling arrangement being secured to said coupling portion.

8. A thrust plate assembly as in claim 7 wherein
said coupling arrangement comprises at least one coupling element having a first end area secured to said coupling portion of said pressure plate, and a second end area secured to a coupling portion of said housing, said first end area extending beyond said coupling portion of said pressure plate and forming said counter-stop area.

9. A thrust plate assembly comprising
a housing,
a pressure plate,
a coupling arrangement coupling said pressure plate to said housing so that said pressure plate is movable relative to said housing in the direction of an axis of rotation,
an energy accumulator supported between said housing and said pressure plate, said energy accumulator loading said pressure plate in an axial direction with respect to said housing, and
an axial path limiting arrangement for limiting axial movement of the pressure plate with respect to the housing in said axial direction, said axial path limiting arrangement comprising a movement stop for said energy accumulator.

10. A thrust plate assembly as in claim 9 wherein said movement stop is provided on said housing.

11. A thrust plate assembly as in claim 9 where in said energy accumulator comprises a radially outer area which acts on the pressure plate, a radially middle area which is supported in both axially directions with respect to the housing, a radial inner area which can be acted upon by a release arrangement, and a portion between said middle area and said inner area which comes into contact with said movement stop when said pressure plate has a predetermined position relative to said housing.

12. A friction clutch comprising a thrust plate assembly, said thrust plate assembly comprising
a housing,
a pressure plate,
a coupling arrangement coupling said pressure plate to said housing so that said pressure plate is movable relative to said housing in the direction of an axis of rotation, and
an axial path limiting arrangement comprising at least one stop area at the housing and at least one counter-stop area at the pressure plate, each said counter-stop area contacting a corresponding said stop area when the pressure plate assumes a predetermined position relative to the housing, thereby limiting axial movement of the pressure plate with respect to the housing.

13. A friction clutch comprising a thrust plate assembly, said thrust plate assembly comprising
a housing,
a pressure plate,
a coupling arrangement coupling said pressure plate to said housing so that said pressure plate is movable relative to said housing in the direction of an axis of rotation,
an energy accumulator supported between said housing and said pressure plate, said energy accumulator loading said pressure plate in an axial direction with respect to said housing, and
an axial path limiting arrangement for limiting axial movement of the pressure plate with respect to the housing in said axial direction, said axial path limiting arrangement comprising a movement stop for said energy accumulator.
